(19) United States
(12) Patent Application Publication
(10) Pub. No.: US 2020/0208815 A1
(43) Pub. Date: Jul. 2, 2020

(54) Customizable Illumination System

(71) Applicant: Allen R Tigert, Belleview, ID (US)

(72) Inventor: Allen R Tigert, Belleview, ID (US)

(21) Appl. No.: 16/238,053

(22) Filed: Jan. 2, 2019

(51) Int. Cl. F21V 21/14; F21V 29/70; F21V 23/02; F21V 21/08; F21V 21/096; F21V 21/088; F21V 23/04

(52) U.S. Cl. CPC F21V 21/14; F21V 29/70; F21V 23/02; F21Y 2115/10; F21V 21/096; F21V 21/088; F21V 23/0435; F21V 21/0832

(57) ABSTRACT

Embodiments of a customizable illumination system are disclosed. The illumination system may include a bracket, a light source, and a power module. Various embodiments of each of these elements can be used in conjunction with the illumination system to affect a desired degree of customization.

This application claims the benefit of provisional application No. 62/613,318, by the same title, filed on Jan. 3, 2018.

### BACKGROUND

### Technical Field

The present application generally relates to an illumination system that permits multiple configurations of support and attachment, permits multiple angles of light direction, permits multiple types of power sources or modules, and allows multiple configurations of light sources. By changing one or more of these attributes, the illumination system can be configured in a customizable fashion to create an optimal light source.

### Description of the Related Art

Illumination devices such as drop lights, flash lights, head lamps, flood lights, spot lights, etc., have been an important part of many industries since the invention of the light bulb over a century ago. Whether, an artist, mechanic, technician, apprentice, or expert, all those who must access or work in areas devoid of plentiful natural light, need a source of adequate illumination to enable them to properly see and work in these dark spaces.

Many such users, however, are not merely in the same situation repeatedly. Rather, they work in multiple places in different locations and with different geometry. To best serve the illumination needs of these varying situations, a customizable lighting configuration is needed. But creating illumination configuration customized for a particular scenario bears with it the cost of customization and creates inefficiencies from having multiple devices for various scenarios.

Accordingly, a need exists to create an illumination device that is so versatile that it may be customized to the particular situation without having to acquire or carry multiple and different illumination systems. Additionally, it is beneficial and expedient when the customization can occur most accurately and reliably with minimal time and effort and in situ. Any such customization features would be desirable. Having them all would be tremendous benefit.

### SUMMARY

According to one embodiment of the disclosure, a system is provided for a customizable illumination device. According to one aspect, a handheld modular illumination system is disclosed wherein the light source, power module, and bracket may be interconnected in any desirable configuration. According to another aspect, a light source, a bracket comprising a first attachment portion for attachment to a surface and further configured to be coupled to the light source, a power module for providing power to said light source and coupled to said light source, are disclosed, wherein the bracket is configured for selective and detachable coupling to the light source and wherein the first attachment portion further comprises two different attachment mechanisms for attachment to a surface.

According to yet another aspect, the handheld modular illumination system includes a light source which comprises a light emitting diode or an organic light emitting diode or is tubular or is comprised of a panel of diodes or is thermally isolated from the mount or further comprises a housing made from heat dispersive material to provide passive cooling or is coupled to a heat sink or is coupled to an active heat dissipation mechanism or is an endoscopic light.

According to yet another aspect, the handheld modular illumination system includes a bracket that is a single integral bracket which couples the light source to the surface.

According to yet another aspect, the handheld modular illumination system includes the power module interposed between the bracket and the surface.

According to yet another aspect, the bracket is attached to a surface with at least one of a hook and loop fastener, ball-to-ball fastener, magnetic surface, hook, eyelet, cable tie, and clamp. According to another aspect, at least two of said items are used. According to yet another aspect, the first attachment portion is configured to detachably adhere to aluminum.

According to another aspect, the light source is controlled by a switch or by a remote control.

According to another aspect, a modular illumination system is disclosed including a light source, a bracket comprising a first attachment portion for attachment to a surface and further configured to be coupled to the light source, a power module for providing power to said light source and coupled to said light source, and wherein the first bracket is configured for selective and detachable coupling to the light source, and wherein the first bracket further includes at least two coupled mounts.

According to yet another aspect, the modular illumination system includes mounts that are interlocking and are further capable of being secured in place in different orientations with respect to one another or are capable of being secured in different orientations enables directing light from the light source in a desired direction.

According to yet another aspect, a modular illumination system is disclosed including a light source, a first mount having a first attachment portion for attachment to the light source, a second mount having a second attachment portion for attachment to an attachment surface, a power module for providing power to said light source and coupled to said light source and wherein the first and second mounts are configured for selective and detachable coupling to each other and to the light source.

According to yet another aspect, a kit of parts is disclosed including a light source having an attachment portion, at least two brackets having a first attachment portion for attachment to an attachment surface and configured to be coupled to the light source, a power module for providing power to said light source and coupled to said light source and wherein each of the brackets is configured to be selectively coupled to the light source.

According to another aspect, a method for providing a customizable modular illumination system is disclosed wherein the light source, power module, and bracket may be interconnected in any desirable configuration. In one aspect, the method includes the steps of providing a light source having an attachment portion, providing at least two brackets, each having a first attachment portion for attachment to an attachment surface and configured to be coupled to the light source, providing a power module for providing power to said light source and coupled to said light source, wherein each said at least two brackets is configured to be selectively coupled to said light source, selecting one of the two brackets based on the desired illumination configuration; and coupling said selected bracket to said light source attachment portion.

### BRIEF DESCRIPTION OF DRAWINGS

FIG. 1 Illustrates an illumination system according to an embodiment of the invention.

FIG. 2 Depicts an attachment portion according to an embodiment of the invention.

FIG. 3 Depicts an attachment portion according to an embodiment of the invention.

FIG. 4 Depicts an attachment portion according to an embodiment of the invention.

FIG. 5 Depicts an attachment portion according to an embodiment of the invention.

FIG. 6 Depicts an attachment portion according to an embodiment of the invention.

FIG. 7 Illustrates a mount in accordance with an embodiment of the invention.

FIG. 8 Illustrates a fixture in accordance with an embodiment of the invention.

FIG. 9 Illustrates an illumination device in accordance with an embodiment of the invention.

FIG. 10 Illustrates an illumination device in accordance with an embodiment of the invention.

FIGS. 11A through 11F Show various embodiments of the illumination devices in accordance with embodiments of the invention.

FIGS. 12A through 12F Illustrate a few embodiments of power modules in accordance with the invention,

FIG. 12G Illustrates a bracket in accordance with an embodiment of the invention.

FIG. 12H Depicts a view of a light source, mount, and fixture in accordance with an embodiment of the invention.

FIG. 13 Depicts an exploded view of a light source, mount, and fixture in accordance with an embodiment of the invention.

FIG. 14 Shows a mount and fixture with a ball joint coupling in accordance with an embodiment of the invention.

FIG. 15 Shows a switch in accordance with an embodiment of the invention.

### DETAILED DESCRIPTION

In the following detailed description, numerous specific details are set forth by way of examples in order to provide a thorough understanding of the relevant teachings. It should be noted, however, that the present teachings may be practiced without such details. In other instances, known methods, procedures, components, or circuitry have been described at a relatively high level, without detail, in order to avoid unnecessarily obscuring aspects of the present teachings.

The present disclosure relates to providing optimal illumination using an illumination system in a variety of configurations and in different spaces. The illumination system may be modular, permitting use of multiple light sources, multiple mounts, and multiple power modules in a manner optimal for the illumination needs of the space being illuminated.

By way of example, the illumination system may be used by service technicians and workers in the medical field during repair of medical systems. One such non-limiting example is performing repairs on MRI machines. MRI machines typically include cabinets and chassis where electronics and mechanical adjustments are located. The guts of the device, including the cabinets and chassis, are typically in tight, relatively inaccessible areas which have no illumination or are very poorly lit. To access these areas for repair, adjustment, or calibration, technicians must work within poorly lit spaces. A few other non-limiting examples include repairs to medical laboratory equipment, which also include tight and poorly lit areas where the guts of the devices are located. Similarly, technicians and workers in gas and oil industries may use the present illumination system to provide illumination in poorly lit areas of pump stations, refineries, pipeline complexes, and fuel tank inspections. Technicians in automotive, recreational vehicles, and aviation industries also need to access electrical and mechanical systems in tight, dark spaces to provide repair, calibration, or inspection. Recreational vehicles may include all-terrain vehicles and four-wheelers, boats and water vessels, and snow mobiles. Computer and machinery technicians may use the present illumination system to work on or repair main frame computers, computer cabinets, network chassis, and under user desks where computer equipment is located, to illuminate the dark interior spaces of those devices, facilitating observation in those spaces and subsequent work or repair. These are but a few examples of where workers require adequate illumination to conduct their work. In summary, the present illumination system may be used in any dark space to provide quick and efficient optimal illumination, in particular if those spaces are small, have unusual configurations, or are hard to access.

In one embodiment, the illumination system of the present invention may be portable. In another embodiment it may be hand-held and light-weight to facilitate transporting the system from one job site to another. One benefit of the present system is that it is highly scalable to suit the particular need or circumstance. It can be made large. But it can also be made so small and light that it is easily carried in the pocket.

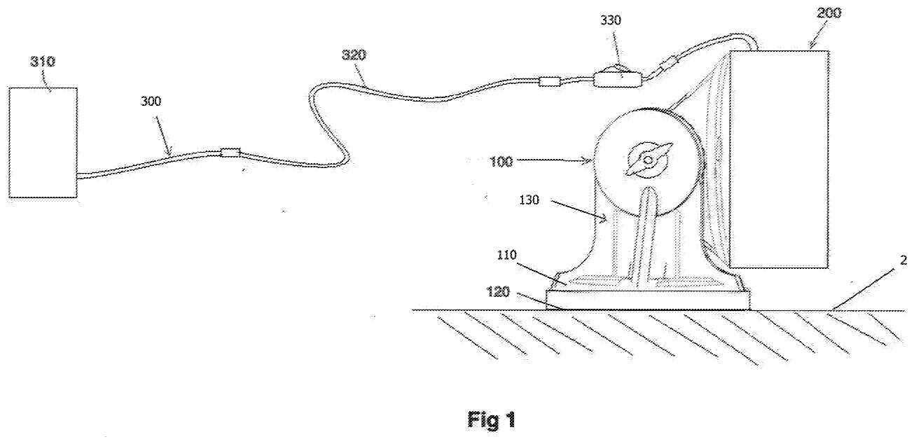

With reference to FIG. 1, illumination system 1 is depicted. Illumination system 1 may include a bracket 100, a light source 200, and a power module 300. Bracket 100 is generally coupled to both the light source 200 and a mounting surface 2.

The bracket 100 may include a base 110. The base 110 may include an attachment portion 120. In operation, the attachment portion 120 will generally be placed on surface 2 from which the light shines. That surface may be the ground, a wall, a beam, table or counter top, portions of a cabinet, machinery, appliance, a cover including a vehicle cover such as a hood or fender, a stand, a tripod, or any surface or location from which the light will shine. Such surface or location will be chosen based on the geometry of the space to be lit and will be selected to provide the optimal requisite illumination. Use of the term surface herein refers to any such location or surface and is not intended to limit the same.

Attachment portion 120 may include ball-to-ball fasteners, hook and loop fasteners such as Velcro®, magnets, threaded nuts, mechanical connections, or any combination thereof. The attachment portion may be directly connected to the base 110, may be formed integral therewith, may be mechanically connected thereto, or glued in place. Mechanical connections, to secure portion 120 to base 110 or to secure portion 120 to the surface, may be of any suitable form, for example by using glue, clips, clamps, suction cups, interlocking portions, interlocking ball fasteners, bolts, nuts, or other fasteners. Various other temporary connections may also be used as the attachment portion 120 to secure base 110 to the surface and may include clamps, fasteners, hooks, eyelets for attachment to a fastener on the surface, removable adhesives, etc.

For aluminum surfaces, for examples in aircraft or water vessels, clamps, hooks, suction cups, or eyelets can be used. For example, eyelets on the surface of portion 120 or the perimeter thereof can be used in combination with a cable tie, such as a zip tie, to secure base 110 to surface 2. Needless to say, if the space to be illuminated includes surfaces to which adhesives, fasteners, or magnets may be applied, any such attachment method may be used.

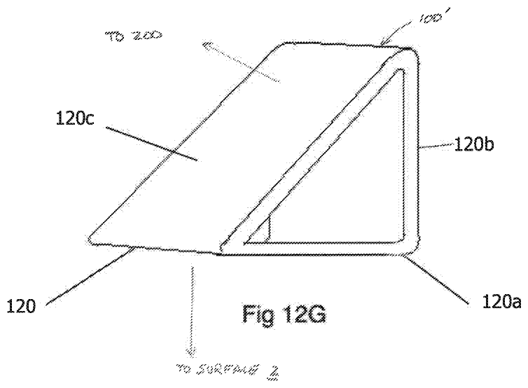

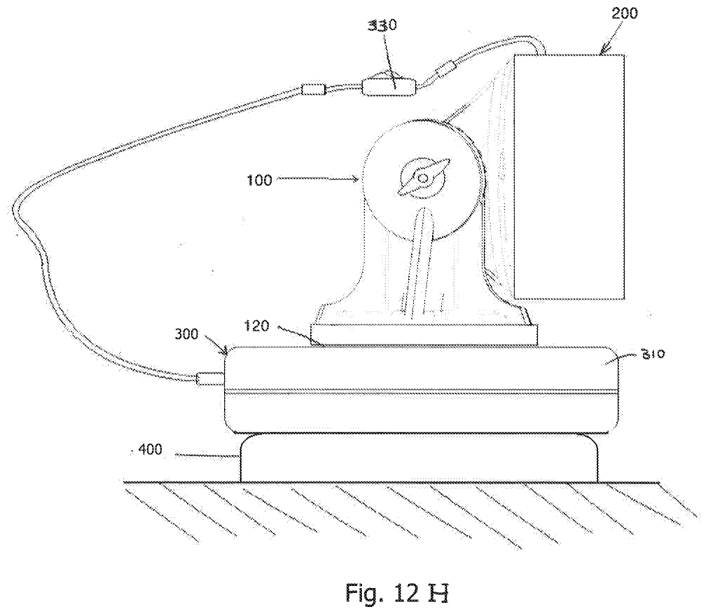

Alternatively, the bracket may be a simple integral mount 100′ as shown in FIG. 12G. Each of the faces 120a, 120b, and 120c may include an attachment portion so that the bracket can be coupled to surface 2 and to the light source 200 via any of the surfaces 120a, 120b, and 120c. In operation, the bracket is coupled to the surface via one of the surfaces, and the light fixture can be coupled to another one of the remaining two surfaces. Note that the bracket need not have a triangular cross section as depicted in FIG. 12G. For example, in the embodiment of FIG. 12G, attachment portion 120 is located on surface 120a. Any of the attachment portions and attachment mechanisms described herein can be used with this embodiment of the bracket (including those described below in FIGS. 2-6). One simple implementation of the attachment portion is using a strip of hook and loop or ball to ball fasteners mounted to each of the surfaces 120a, 120b, and 120c. This embodiment is particular advantageous with very small implementations of the illumination device but is not limited thereto.

FIGS. 2-6 illustrate a few examples of the attachment portion 120. Portion 120 may include ball-to-ball fasteners 121 secured to the side of portion 120 facing surface 2. Fasteners 121 may be ball-to-ball, hook and loop, magnets, or any other type as previously described. Fasteners 121 may be in the form of semi-circular strips as shown in FIG. 2, or in the form of rings or circles. Fasteners 121 may be formed in any shape and size so long as they provide a secure connection between the base 110 and surface 2. Those shapes are not limited to the few depicted in FIGS. 2-6.

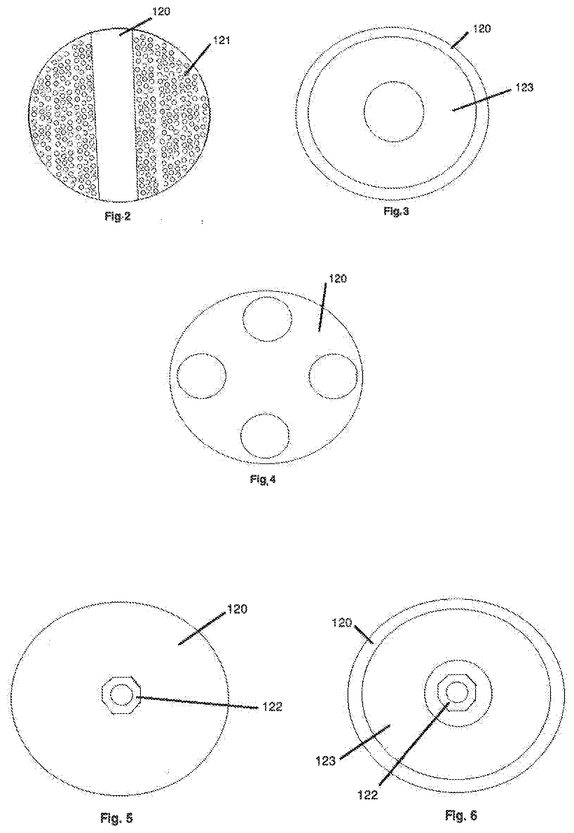

FIG. 3 depicts a magnet 123 on attachment portion 120. FIG. 4 shows four suction cups on portion 120. Alternatively, in addition to or in lieu of fasteners 121, other hardware or mechanical connections may be used. One such example is shown in FIG. 5 which depicts a through hole 122. Through hole 122 may be threaded for coupling with an existing bolt on surface 2. Where base 110 will be secured to a tripod or stand instead of surface 2, the through hole 122 can couple to a bolt on the tripod or stand. Alternatively, through hole 122 can operate as a keyhole or opening in portion 120 which allows base 110 to be secured to a protrusion or fastener on surface 2. The through hole 122 need not be round or centered on portion 120 or threaded. It need not extend completely through the portion 120. Rather, it may be of any known configuration or depth that facilitates securement of base 110 to surface 2, to a tripod, or to a stand. Moreover, various forms of the attachment depicted in FIGS. 2-6 may be combined. One such example is depicted in FIG. 6 in which through hole 122 is combined with magnetic portions 123 on the same attachment portion 120.

In addition to the attachment mechanisms shown in FIGS. 2-6, other attachment mechanisms can also be used and various attachment mechanisms may be combined. For example, magnetic portions may be combined with ball-to-ball fastener portions, or a threaded nut configuration may be combined with magnetic portions or with ball-to-ball fastener portions.

Bracket 100 may include the attachment mechanism, such as attachment portion 120, directly on the base 110 as shown in FIGS. 2-6. Alternatively, it may include an intervening portion attached to the base 110 to which the attachment portion 120 is secured. The foregoing are but a few examples and not intended to limit the mechanisms and combinations for attachment. One such intervening portion may be power module 300 which may be interposed between attachment portion 120 and base 110 as depicted in FIG. 12H.

In FIG. 12H, the assembly is stacked with power module 300 coupled to the surface with an attachment portion (similar to portion 120) which may be a magnet 400. Nevertheless, portion 400 may be any of the aforementioned described attachment mechanisms and is not limited to a magnet.

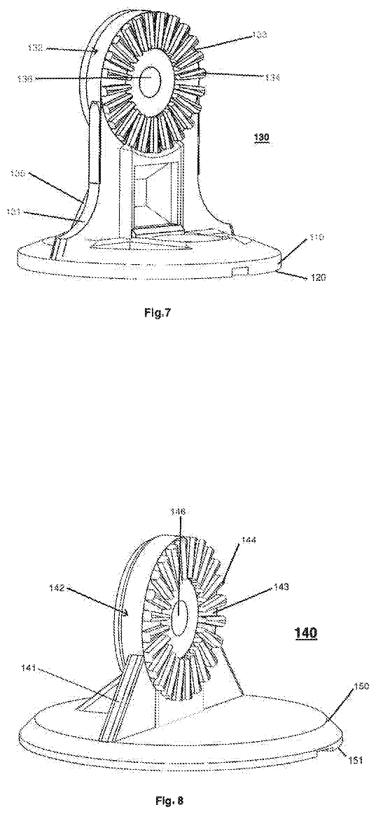

Returning to FIG. 1, bracket 100 may include a base mount 130 and light fixture 140. An embodiment of mount 130 on base 110 is shown in FIG. 7. An embodiment of fixture 140 is shown in FIG. 8. The particular embodiment of mount 130 as shown in FIG. 7, includes risers 131. Risers 131 connect base 110 to joint 132. Risers 131 may be of any configuration to provide connection of the joint to the base. Joint 132 may be of any shape but is depicted as round in FIG. 7. Joint 132 includes a mating surface 133. In the embodiment of FIG. 7, mating surface 133 is a toothed surface with teeth 134.

Mount 130 may also include mechanisms for improving structural integrity. Structural integrity may include, for example, rigidity, strength, or durability. It may also include resisting vibration, or reducing motion, or lessening deformation. Where improved structural integrity is desirable, mount 130 may include elements to accomplish so. In the embodiment of FIG. 7, mount 130 includes buttresses 135 which act as stiffeners to increase rigidity and to enhance strength.

Mating surface 133 may be of any configuration which permits coupling with or mating with surface 143 on fixture 140 (more fully described below, see also FIG. 8). For example, mating surface 133 may be toothed as shown in FIG. 7. It may also be an indexed surface. It may also be a flat mating surface, or it may roughened or bubbled. Bubbled mating surfaces include depressions and protrusions, for example in the shape of hemispheres that interlock when mating surfaces are brought together. When using bubbled mating surfaces, the distribution of depressions and protrusions on a mating surface need not be homogenous. They may be configured in any particular way to permit coupling in a specific orientation. Such mating surfaces are used when it is desirable to align the orientation of the mating surfaces. With respect to the present invention, bubbled mating surfaces may be used to force the mating surface 133 to align in a specific direction. Such a forced alignment may be desirable where the orientation of the light source should be regulated, for example, with respect to light sources with a focused or narrow beam. Moreover, a combination of styles of mating surfaces may be used together on mount 130.

Mount 130 also includes a fastener portion 136. In the embodiment of FIG. 7, the fastener portion 136 is a portion which may include an opening through which a bolt can be inserted. The bolt may be secured in place with a wingnut or the like. Fastener portion 136 can be configured for any known fastener which permits coupling of mount 130 to a mating fixture 140 described more fully below with respect to FIG. 8. Some non-limiting examples of fastener portions may include an opening for use with a bolt or screw (as shown in FIG. 7), a built-in fastener such as captive nut or bolt, a rod, a ball coupling, etc.

The coupling of mount 130 to mating fixture 140 may alternatively be a spring-loaded rod that attaches to the two mating surfaces 133 and 143. When the two surfaces 133 and 143 are forcibly separated, the spring is extended and the surfaces disengaged and can be rotated with respect to each other. Upon release, the two surfaces couple and the spring resumes its relaxed state.

Any known coupling mechanism can be used as the fastener portion so long as it couples mount 130 to fixture 140. As can readily be recognized by a person of ordinary skill, if the manner of coupling mount 130 to fixture 140 is with ball joints or other couplers that do not require mating surfaces similar to surface 133, the mating surface can be omitted and the risers will terminate in the fastener portion which in turn, couples to fixture 140. FIG. 14 shows an embodiment of mount 130 and fixture 140 having a ball joint coupling mechanism.

Alternatively, to provide for adjustability in the mounting mechanism, any known joint mechanism can be used in place of mount 130 and fixture 140. Alternatively, mount 130 and fixture 140 may be permanently secured to one another or even made as an integral piece.

FIG. 8 shows one embodiment of light fixture 140 which may be coupling to the embodiment of mount 130 as shown in FIG. 7. Light fixture 140 includes a plate 150, with surface 151, which is secured to light source 200. The plate 150 may be secured to the light source 200 in any fashion, for example as previously disclosed with respect to attachment portion 120. That is, plate 150 may be secured to light source 200, through surface 151, with ball-to-ball fasteners, etc. Alternatively, plate 150 may be secured to the light source by any of the securing mechanisms described with respect to base 110 or attachment portion 120. Nevertheless, the securing mechanism on plate 150 does not have to be the same mechanism used on base 110 or attachment portion 120. That is, each of the securing mechanisms on the plate 150 and base 110 may be selected from various alternatives but they do not have to be identical implementations.

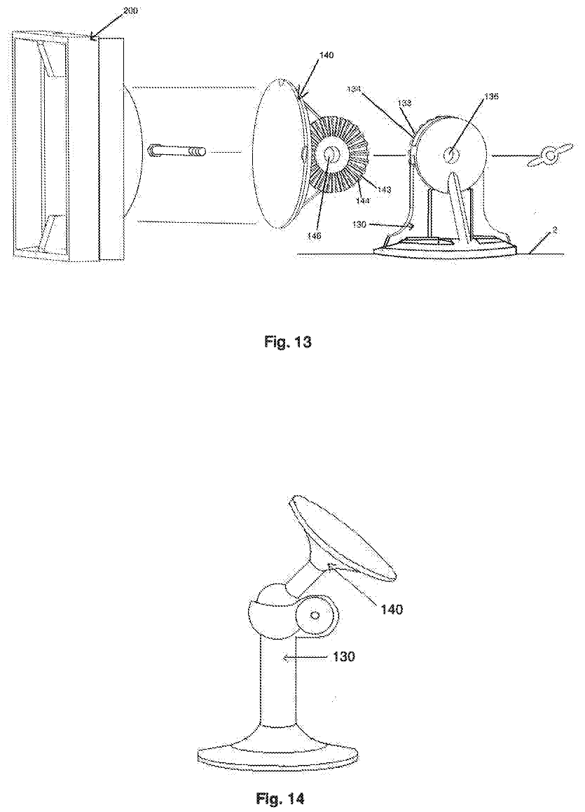

Light fixture 140 may also include light fixture risers 141, light fixture joint 142, light fixture mating surface 143. Light fixture mating surface 143 may include mating teeth 144 which interlock with teeth 134 of mating surface 133 as shown in FIG. 7. An exploded view showing the connection of mount 130 and mating surface 133 with fixture 140 and mating surface 143 is shown in FIG. 13.

For embodiments where the mating surface 133 includes alternative mating surfaces, such as bubbled, indexed, or otherwise, light fixture mating surface 143 is configured correspondingly to couple with mating surface 133. That is, the surface configuration of 143 is complimentary to 133 to securely mate with it. In the example of the embodiment shown in FIGS. 7 and 8, mating surface 133 includes teeth 134 and surface 143 includes corresponding teeth 144.

Referring again to FIG. 8, light fixture 140 may also include a light fixture fastener portion 146. In the embodiment of FIG. 8, the light fixture fastener portion 146 is a portion which may include an opening through which a bolt can be inserted. This bolt would be the same bolt which is inserted through fastener portion 136 as shown in FIG. 7. The bolt may be secured in place with a wingnut or the like as explained with respect to FIG. 7. Mating fixture fastener portion 146 can be any configuration that corresponds to fastener portion 136 and enables securement of mount 130 to fixture 140. FIG. 13 shows one embodiment of mount 130 and fixture 140 with a fastener that secures them.

In operation, referring to FIGS. 1 and 13, light fixture 140, which is coupled to the light source 200, is brought proximate to mount 130, located on base 110. Mating surface 133 is mated with mating surface 143 so that mount 130 and light fixture 140 become securely connected. Thereafter, a bolt or fastener may be inserted through the openings in portions 136 and 146, in embodiments where fasteners are used. The bolt or fastener is then secured in place with a wingnut or the like, in embodiments where wingnuts are used. As mount 130 is firmly attached to light fixture 140, the mating surfaces 133 and 143 engage and teeth 134 and 144 prevent the surfaces from rotating with respect to each other. Accordingly, light source 200 is adjustably and removably coupled to bracket 100, but that coupling is firmly secured in place without the risk for slippage or rotation.

In addition to the embodiments described above, the bracket 100 may be a single integral piece including the base, attachment portion, and mount made as a single, integral component. FIG. 12G is an embodiment where the mounts coupling to surface 2 and to the light source are formed in a single integral piece. Alternatively, bracket 100 may be composed of the various pieces joined together permanently or removably. Moreover, as previously discussed, mount 130 and fixture 140 may be integrally formed as one piece or may be formed as separate pieces that are coupled together.

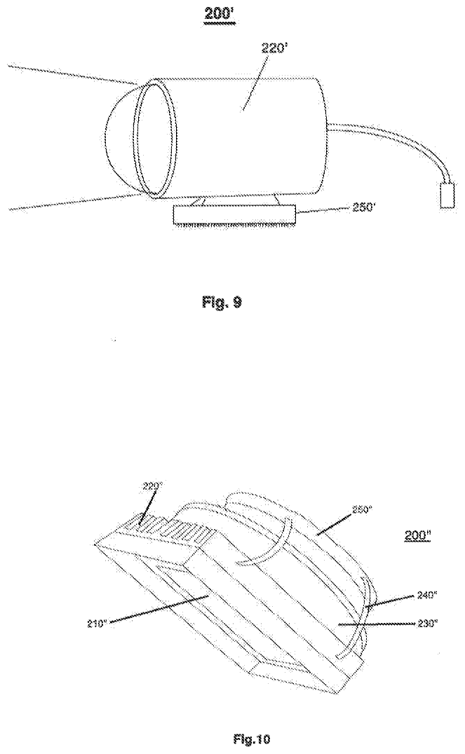

When a simple connection without the need for joints or adjustments is desirable, bracket 100, including mount 130 and corresponding fixture 140, may be altogether replaced with a simple attachment. The embodiment of FIG. 12G shows one such embodiment. Others such embodiments are also shown including FIG. 9 which is more fully explained below.

Referring again to FIG. 1, the light source 200 may be chosen from a variety of sources. The sources can be selected to provide focused light or to provide a wide beam. For example, they may be flood lights or spot lights. They may also be coherent or dispersed light. They may emit in the visible spectrum or in the invisible spectrum, including ultraviolet and infrared. Some examples of lights may be LED (light emitting diodes), OLED (organic light emitting diode), lasers, or other light emitting sources. Incandescent and halogen lights may also be used as the light source.

In one embodiment, the light source may include an LED source. LEDs may be panel lights or spot lights. FIG. 9 shows an LED spotlight 200′. Light 200′ is comprised of an LED which is inside the housing depicted in FIG. 9. The housing includes a lens which focuses the light generated by the LED into a spotlight. The housing is made of a heat dispersing material which provides passive cooling for the LED. The housing is coupled to base 250′. Any bracket described herein can be used for base 250′, including the bracket shown in FIG. 12G.

A lens mechanism which may be used in conjunction with the light source may take any known form. Many configurations of lenses are available on the market. Moreover, various mechanisms, which permit adjustments for different illumination effects, are available on the market. For example, certain lens mechanisms allow a light beam to be adjusted from a narrow beam or spot light to a wide beam or floodlight.

LED lights can also be panel lights such as that shown in FIG. 10. LED lights typically require cooling for optimal performance. Where the LED is sufficiently small, heat generated by the LED dissipates in ambient air. The stronger the intensity of the LED light, the more heat it will generate. Ultimately, some LEDs may require cooling. Cooling may be passive or active.

Passive cooling may include structural components which direct heat away from the LED so that it may dissipate. The housing of light source 200′ in FIG. 9 acts as a heat sink and provides passive cooling. For even smaller LED lights, a strip of aluminum backing or the like may be sufficient to provide the requisite cooling. On the other hand, where the LED has a stronger output, passive cooling is sometimes not sufficient. In those instances, active cooling can be used. Active cooling may include use of fans or other cooling devices to dissipate the heat. Other cooling devices include solid state cooling devices or fluid coolers. Active and passive cooling may be and often are used in combination.

The embodiment of FIG. 10 depicts a high intensity LED light source 200″ which is both actively and passively cooled. Light source 200″ includes LED panels 210″. Panels 210″ are attached to a heat sink 220″. The heat sink 220″ is attached to fan 230″. The entire assembly of light source 200″ is mounted on base 250″. Base 250″ may be coupled to fixture 140 or may be coupled directly to plate 150 on bracket 100. Alternatively, any bracket described herein can be used for base 250′, including the bracket shown in FIG. 12G. In such a configuration, light source 200″ is coupled to a surface 120b (or 120c) which is not coupled to surface 2.

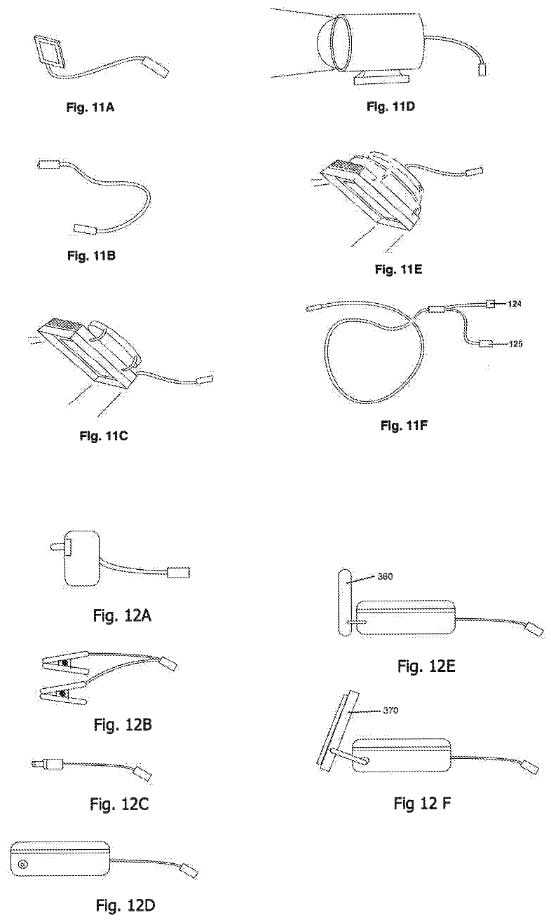

FIGS. 11A-11F show a few other examples of light sources. The particular examples shown in FIGS. 11A-11F are highly scalable. FIG. 11A depicts an LED panel light. This configuration is particularly suited for miniaturization. It may be constructed to be simple and lightweight. FIG. 11B depicts an LED tubular light. It too is particularly suited to miniaturization. FIG. 11C shows an LED flood light with an external heat sink. FIG. 11D shows a spot light in a housing. FIG. 11E depicts a high-powered light with active and passive cooling. FIG. 11F depicts an endoscopic light. The particular example of FIG. 11F shows USB connector 124 which may provide various output data including video. Portion 125 couples to a power module. Endoscopic lights are also particularly suited to be made very small or very thin.

In the embodiments of FIGS. 9 and 10, bases 250′ and 250″ may be coupled to the light fixture on the bracket, for example fixture 140 on bracket 100 (FIGS. 1 and 13). However, bases 250′ and 250″ may also be directly coupled to surface 2 as illustrated in FIG. 1. That is, instead of attaching bracket 100 to surface 2 with attachment portion 120, and then coupling bracket 100 to the light sources (at bases 250′ and 250″), bases 250′ or 250″ may be directly coupled to surface 2. The bases may be coupled using any known method, many of which have previously been disclosed, for example with respect to attachment portion 120. For example, magnets may be used to attach to a metal surface, ball-to-ball and hook and look fasteners may be used to removably secure to a surface, etc. Various other connections may also be used include clamps, fasteners, hooks, eyelets, removable adhesives, etc.

Referring again to FIG. 9, the light source 200′ is comprised of a housing 220′ which includes the LED source inside (not shown). The housing is connected to a power module, for example, power module 300 as shown in FIG. 1. The housing is also connected to base 250′. In the embodiment of FIG. 9, the housing is bolted to base 250′. Nevertheless, any suitable attachment method, many examples of which have already been disclosed, may also be used.

The light source may be connected to the base in any manner that provides a secure attachment and also provides the requisite degree of thermal isolation between the light source and the base. In the embodiment of FIG. 9, the housing is directly bolted to base 250′. In the embodiment of FIG. 10 a wire bracket is used. Nevertheless, various coupling mechanisms, many of which have already been disclosed, may be used.

Referring again to FIG. 10, LED panels 210″, heat sink 220″ and fan 230″ are assembled into light source 200″. The assembly may be permanent or removable. It may be via adhesive, mechanical connection, or by enclosure, for example, by a housing, molding, or potting. Moreover, pre-packaged LED units, integral with their heat sink, may be used as light source 200″.

Additionally, source 200″ may include circuitry to prevent overheating. Various circuits or switches, including solid state or thermal switches, can be included in the electrical path to the LED to break the circuit when the LED becomes too hot and to prevent overheating. Alternatively, off the shelf circuit modules and packages that ensure optimal operation by temperature control through switches or feedback loops for input control are known and may be used without limitation with light source 200″. By way of one example, such circuitry or packages may be incorporated into base 250″, mounted onto it near fan 230″, or attached to heat sink 220″.

Various circuitry or controllers for the light source 200″ may also be incorporated into the power module 300. This is beneficial for configurations where the light source is small.

The source 200″ is secured to base 250″ through wire brackets 240″ that are connected at one end to disc 250″ and clamped at the other to source 200″, for example onto heat sink 220″ as shown in FIG. 10. The source 200″ may be preconfigured with indentations or attachment portions for the bracket if desired. Such portions may be on the heat sink, on the light source, or on an external housing if one exists. Moreover, any suitable attachment mechanism such as clamps, fasteners, and the like, as detailed previously, can be used in lieu of wire brackets 240″. Wire brackets 240″ are secured to base 250″ by any suitable means. Such suitable means may include any of the many attachment mechanisms previously discussed.

Referring again to FIG. 1, the illumination device includes a power module 300. The power module includes a power source 310 and connecting cable 320. FIG. 1 depicts connecting cable 320. Nevertheless, it should be recognized, that any configuration of an extension cord or cable can be added to the system to allow additional flexibility in placement of the light source with respect to the power supply and the bracket.

Power source 310 may be selected from an AC (alternating current) source or a DC (direct current) source. The power source 310 may be a self-contained or a portable unit, such as a battery pack, or it may be an interface to an existing source such as to a battery, to a DC source (3, 5, 12, 28, etc. volts), or to an AC outlet. For example, the power source 310 may attach to a battery via clamps or connectors. Many such connections are known in the art. Alternatively, the power source 300 may attach to a DC power socket such as a car charging jack or a cigarette lighter jack via the appropriate connector. Alternatively, the power source may include a USB or similar connector for coupling to a DC source. Alternatively, the power source 310 may include an AC connector that couples to an AC outlet. Alternatively, it may include an AC adapter that couples to an AC source. In one embodiment, an AC-DC adapter may be a 12 volt adapter converting AC to 12 volts DC, for example at 3 amps.

FIGS. 12A-12F show a few examples of these various embodiments for power source 310. FIG. 12A depicts an AC adaptor. FIG. 12B shows battery clamps. FIG. 12C illustrates a 12V jack. FIG. 12D illustrates a battery pack. FIG. 12E shows power source coupled to a wireless charging mechanism 360. FIG. 12F shows power source coupled to a solar charging station 370. It should be noted that there are many interfaces for power supplies known in the art and many types of jacks and connectors serve these functions. Any known configuration of such connection and jacks with known power sources can be used with respect to power module 300 and power supply 310. Moreover, it should be noted that either mechanisms 360 or 370 may be integrated into the existing housing of source 310.

A battery pack may be composed of regular batteries or rechargeable batteries. For example, the battery pack may be composed of lithium ion batteries. In one embodiment, the battery pack may be composed of rechargeable lithium ion batters, for example, operating at 12 volts at 3 amps. In one embodiment, the battery pack may be coupled to a wireless charger for inductive or capacitive wireless power transfer.

Power module 300 may also include a switch unit 330. Switch unit 330 may be incorporated into the power source 310, connecting cable 320, bracket 100, or light source 200. In the embodiment of FIG. 1, the switch unit 330 may be a simple on-off switch which is incorporated into connecting cable 320. The switch may also be any other switch described herein, for example, it may be a dimmer switch or a remote control switch.

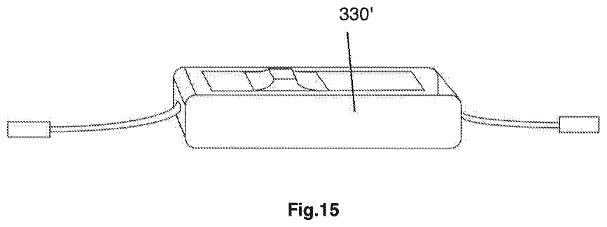

The system of the present invention may also be configured to be capable of controlling the direction, intensity, or mode of illumination. One such control may be a dimmer switch or control to vary the intensity of the emitted light. On such example is depicted in FIG. 15. FIG. 15 illustrates a sliding dimmer switch 330′. Switch 330′ can be located similarly to 330 as depicted in FIG. 1. Alternatively, it may be located in other portions of system 1 as further described below.

Moreover, system 1 may include voice control for such configurations. Or it may include remote control, for example, remote control via blue tooth technology or IR or other remote protocols.

The circuitry for controlling the operation, direction, intensity, or mode of the system may be incorporated into any portion. It may even be incorporated into extension cords which can be selectively connected to power supply 310 or cable 320. Each such implementation will have particular benefits. For example, where such circuitry is incorporated into an off-the-shelf power module, it is advantageously contained with the power source. Where convenience demands that the circuitry is located in a portion of the cable 320 for proximity to the operator, it may be incorporated so. In other applications, for example in tight spaces, it may be advantageous to place the switch near the light source 200 for easy access and operation.

The present invention has been described using some examples as illustrated above. In practice, the invention may be formed as one or more devices which may be provided or sold individually to consumers. Alternatively, one or more of the aspects of the invention can be packaged together and sold collectively. Moreover, the present invention may be formed into kits which include one or more of the elements of the invention included in a kit and provided to consumers. Such kits may be formed with various alternative embodiments for aspects of the invention so that the consumer can assemble the parts and customize the illumination device to his or her need. Moreover, the parts and kits may be formed in ways that permit such customization in situ or without tools. The present invention may be scaled as noted above and any corresponding kit may include different sizes of components. In summary, the aspects of the invention described herein can be adjusted and scaled as described above to provide a maximally customizable illumination system.

While the foregoing has been described in conjunction with examples and embodiments, it is understood that such characterizations are merely meant as a description tool, rather than the best or optimal manner of implementing the invention.

Except as stated above, nothing that has been stated or illustrated is intended or should be interpreted to cause a dedication of any component, step, feature, object, benefit, advantage, or equivalent to the public, regardless of whether it is or is not recited in the claims.

It should be understood that the terms and expressions used herein have the ordinary meaning as is accorded to such terms and expressions with respect to their corresponding respective areas of inquiry and study except where specific meanings have otherwise been set forth herein.

What is claimed is:

1. A handheld modular illumination system wherein the light source, power module, and bracket may be interconnected in any desirable configuration comprising
a light source;
a bracket comprising a first attachment portion for attachment to a surface and further configured to be coupled to the light source;
a power module for providing power to said light source and coupled to said light source;
wherein the bracket is configured for selective and detachable coupling to the light source;
wherein the first attachment portion further comprises two different attachment mechanisms for attachment to a surface.

2. A handheld modular illumination system according to claim 1 wherein the light source comprises a light emitting diode or an organic light emitting diode.

3. A handheld modular illumination system according to claim 1 wherein the light source is tubular.

4. A handheld modular illumination system according to claim 1 where the light source is comprised of a panel of diodes.

5. A handheld modular illumination system according to claim 1 wherein the light source is thermally isolated from the mount.

6. A handheld modular illumination system according to claim 1 wherein the light source further comprises a housing made from heat dispersive material to provide passive cooling.

7. A handheld modular illumination system according to claim 1 where the light source is coupled to a heat sink.

8. A handheld modular illumination system according to claim 1 wherein the light source is coupled to an active heat dissipation mechanism.

9. A handheld modular illumination system according to claim 1 wherein the light source is an endoscopic light.

10. A handheld modular illumination system according to claim 1 wherein the bracket is a single integral bracket which couples the light source to the surface.

11. A handheld modular illumination system according to claim 1 where the power module is interposed between the bracket and the surface.

12. The modular illumination system according to claim 1 wherein said bracket is attached to a surface with at least one of a hook and loop fastener, ball-to-ball fastener, magnetic surface, hook, eyelet, cable tie, and clamp.

13. The modular illumination system according to claim 1 wherein said bracket is attached to a surface with at least two of a hook and loop fastener, ball-to-ball fastener, magnetic surface, hook, eyelet, cable tie, and clamp.

14. A modular illumination system according to claim 1 wherein said first attachment portion is configured to detachably adhere to aluminum.

15. A modular illumination system according to claim 1 wherein the light source is controlled by a switch.

16. A modular illumination system according to claim 1 wherein the light source is controlled by a remote control.

17. A modular illumination system wherein the light source, power module, and bracket may be interconnected in any desirable configuration comprising
a light source;
a first bracket comprising a first attachment portion for attachment to a surface and further configured to be coupled to the light source;
a power module for providing power to said light source and coupled to said light source;
wherein the first bracket is configured for selective and detachable coupling to the light source; and
wherein the first bracket further comprises at least two coupled portions.

18. A modular illumination system according to claim 17 wherein the portions are interlocking and are further capable of being secured in place in different orientations with respect to one another.

19. A modular illumination system according to claim 17 wherein said capability of being secured in different orientations enables directing light from the light source in a desired direction.

20. A modular illumination system wherein the light source, power module, and bracket may be interconnected in any desirable configuration comprising
a light source;
a first mount comprising a first attachment portion for attachment to the light source;
a second mount comprising a second attachment portion for attachment to an attachment surface;
a power module for providing power to said light source and coupled to said light source;
wherein the first and second mounts are configured for selective and detachable coupling to each other and to the light source.

21. A kit of parts for a modular illumination system having a light source, power module, and bracket that may be interconnected in any desirable configuration comprising
a light source comprising an attachment portion;
at least two brackets each comprising a first attachment portion for attachment to an attachment surface and configured to be coupled to the light source;
a power module for providing power to said light source and coupled to said light source;
wherein each of said at least two brackets is configured to be selectively coupled to said light source.

22. A method of providing a customizable modular illumination system wherein the light source, power module, and bracket may be interconnected in any desirable configuration comprising the steps of
providing a light source comprising an attachment portion;
providing at least two brackets, each comprising a first attachment portion for attachment to an attachment surface and configured to be coupled to the light source;
providing a power module for providing power to said light source and coupled to said light source;
wherein each said at least two brackets is configured to be selectively coupled to said light source;
selecting one of said at least two brackets based on the desired illumination configuration; and
coupling said selected one of said one of said at least two brackets to said light source attachment portion.
